(19) United States
(12) Patent Application Publication
(10) Pub. No.: US 2011/0159398 A1
(43) Pub. Date: Jun. 30, 2011

(54) LOW COMPRESSIVE LOAD SEAL DESIGN FOR SOLID POLYMER ELECTROLYTE FUEL CELL

(75) Inventors: Simon Farrington, Vancouver (CA); Robert H. Artibise, Vancouver (CA)

(73) Assignee: DAIMLER AG, Stuttgart (DE)

(21) Appl. No.: 13/062,541

(22) PCT Filed: Sep. 9, 2009
(86) PCT No.: PCT/US09/56347

§ 371 Date: Mar. 7, 2011

Related U.S. Application Data
(60) Provisional application No. 61/095,402, filed on Sep. 9, 2008.

(51) Int. Cl. H01M 2/08; H01M 8/24; H01M 8/00

(52) U.S. Cl. 429/469; 429/508; 429/535

(57) ABSTRACT

A low compressive load seal for a solid polymer fuel cell employs two offset peripheral projections, one on each of the anode and cathode separator plates, for compressing a gasket. The design can achieve a seal against a given burst pressure with a lower load normal to the separator plates by creating significant compression parallel to the separator plates in the gap between the offset projections. The design allows for thinner fuel cell constructions while avoiding the issues that arise in prior art designs (e.g., stress on seal material and component crushing) if reasonable tolerances were allowed for variations in component thickness.

### BACKGROUND

1. Technical Field

The present invention relates to gasket seal designs for solid polymer electrolyte fuel cells.

2. Description of the Related Art

Fuel cells are devices in which fuel and oxidant fluids electrochemically react to generate electricity. A type of fuel cell being developed for various commercial applications is the solid polymer electrolyte fuel cell, which employs a membrane electrode assembly (MEA) comprising a solid polymer electrolyte made of a suitable ionomer material (e.g., Nafion®) disposed between two electrodes. Each electrode comprises an appropriate catalyst located next to the solid polymer electrolyte. The catalyst may be, for example, a metal black, an alloy, or a supported metal catalyst such as platinum on carbon. The catalyst may be disposed in a catalyst layer, and the catalyst layer typically contains ionomer, which may be similar to that used for the solid polymer electrolyte. A fluid diffusion layer (a porous, electrically conductive sheet material) is typically employed adjacent to the electrode for purposes of mechanical support and/or reactant distribution. In the case of gaseous reactants, such a fluid diffusion layer is referred to as a gas diffusion layer. If a catalyst layer is incorporated onto a gas diffusion layer, the unit is referred to as a gas diffusion electrode (GDE).

For commercial applications, a plurality of fuel cells are generally stacked in series in order to deliver a greater output voltage. Separator plates are typically employed adjacent the gas diffusion electrode layers in solid polymer electrolyte fuel cells to separate one cell from another in a stack. Fluid distribution features, including inlet and outlet ports, fluid distribution plenums and numerous fluid channels, are typically formed in the surface of the separator plates adjacent the electrodes in order to distribute reactant fluids to, and remove reaction by-products from, the electrodes (such separator plates are referred to as flow field plates). Flow field plates also provide a path for electrical and thermal conduction, as well as mechanical support and dimensional stability to the MEA.

In an assembled fuel cell, the porous gas diffusion layers in the MEA must be adequately sealed at their periphery and to their adjacent separator or flow field plates in order to prevent reactant gases from leaking over to the wrong electrode or out of the fuel cell stack. This can be challenging because the MEA is typically a relatively large, thin sheet, and thus a seal may be needed over a significant perimeter, and a fuel cell stack typically involves sealing numerous MEAs. Design of the MEA edge seal should provide for production in high volume and yield a highly robust MEA. Various ways of accomplishing this have been employed in the art.

A typical method involves use of a sealing gasket which surrounds the MEA and is compressed between the anode and cathode separator plates, thereby effecting a seal between MEA and ambient. The seal needed to separate the anode and cathode may be achieved in several ways, and which may preferably involve integration with the gasket surrounding the MEA. For instance, for ease of manufacture, a commercial MEA is preferably made in a continuous laminated manner and then cut to a preferred size. This results in what is known as a flush-cut MEA, wherein the edges of the membrane electrolyte, electrodes, and gas diffusion layers are aligned and terminate at the same location (i.e., at the flush-cut edge). U.S. Pat. No. 6,057,054 discloses such flush-cut MEAs with impregnated edge seals and an integral gasket, wherein a flow processable elastomer such as silicone is employed as the impregnant.

In order to increase power density, fuel cell makers continually attempt to reduce the thickness of the individual cells making up a fuel cell stack. In practice however, realistic tolerances are required for the thicknesses of the various components used in the stack. As fuel cell thickness decreases, fuel cell makers face a challenge in accommodating the possible variations allowed within the component thickness tolerances. For instance, with so many thinner cells involved, the tolerance stackup may result in insufficient compression of certain seals and/or gaskets if certain components are at the thin end of a tolerance range. Conversely however, the tolerance stackup may result in excessive stress on the seal material and overcompression and damage to certain cell components (e.g., flow field distribution channels) if certain components are at the thick end of a tolerance range. Both situations must be avoided for an overall acceptable manufacturable design. Consequently, there remains a need in the art for improved methods and designs to address this challenge. The present invention fulfills this need and provides further related advantages.

### BRIEF SUMMARY

A low compressive load seal for a solid polymer fuel cell can be achieved using a seal design that employs two offset peripheral projections, one on each of the anode and cathode separator plates, to compress a gasket. The design can achieve a seal against a given burst pressure with a lower load normal to the separator plates. This is done by creating significant compression of the gasket parallel to the separator plates (as opposed to be perpendicular to them) in the gap between the projections. This allows for a thinner fuel cell design without requiring impractical tolerances on the thicknesses of the cell components.

The solid polymer electrolyte fuel cell comprises a membrane electrode assembly comprising an ionomer electrolyte disposed between an anode and a cathode, an anode fluid diffusion layer adjacent the anode, and a cathode fluid diffusion layer adjacent the cathode. There is also an anode separator plate adjacent the anode fluid diffusion layer, a cathode separator plate adjacent the cathode fluid diffusion layer, and a gasket surrounding the membrane electrode assembly. The gasket is compressed between the anode and cathode separator plates so as to seal the membrane electrode assembly between the plates.

In this low compressive load seal, each of the anode and cathode separator plates comprises a peripheral projection facing the opposite separator plate. The projections are proximate but offset with respect to each other, and each projection comprises a projection surface and inner and outer projection sidewalls. The separator plates therefore define an anode projection gap between the anode plate projection surface and the cathode plate, a cathode projection gap between the cathode plate projection surface and the anode plate, and an adjacent sidewall gap between the adjacent projection sidewalls of the anode and cathode plate projections.

To obtain significant compression of the gasket parallel to the separator plates, the adjacent sidewall gap is chosen to be greater than the uncompressed gasket thickness if the separator plates were separated in a direction normal to the plane of the separator plates such that the larger of the anode and cathode projection gaps equaled the uncompressed gasket thickness. Then, when assembled, each projection surface applies a compressive load to the gasket in a direction normal to the separator plates thereby displacing gasket material from the projection gaps into the adjacent sidewall gap. And then, the volume in the adjacent sidewall gap is completely filled with gasket material and the adjacent sidewalls of the anode and cathode projections apply a compressive load to the gasket at least in part in a direction parallel to the separator plates.

In the low compressive load seal, the anode and cathode projection gaps are large enough to prevent the strain on the gasket in the projection gaps from exceeding the gasket material strain to failure. The gasket may, for instance, be compressed up to 25% in thickness in the anode and cathode projection gaps, and may preferably be compressed more than 10%. The gasket itself may be made of silicone based elastomer.

In one embodiment, the dimensions of the anode plate projection are the same as the dimensions of the cathode plate projection. The widths of the projection surfaces are about equal to or greater than the heights of the projection surfaces. And, the sidewalls are at an angle of greater than 15 degrees with respect to a direction normal to the separator plates.

Other embodiments may comprise an additional peripheral projection on one of the separator plates, in which the additional projection faces the opposing separator plate and is proximate to but offset from the projection on the opposing plate.

With this low compressive load seal, burst pressures greater than about 2.5 bar and compressive loads at the anode and cathode projection surfaces less than 0.25 N/mm can be achieved.

The invention can be used in fuel cell embodiments in which the separator plates are made of carbon and in which the gasket is attached to and impregnated into an edge portion of the membrane electrode assembly. Alternatively, the gasket could be attached to a frame, which in turn is attached to the edge portion of the MEA.

A plurality of the fuel cells may be assembled in a series stack to make a fuel cell stack. If the separator plates comprise depressions opposite the projections, the depressions can define channels for coolant to flow between adjacent anode and cathode separator plates. Alternatively, the anode separator plates of fuel cells in the stack may be made unitary with the cathode plates of the adjacent fuel cells in the stack.

These and other aspects of the invention will be evident in view of the attached figures and the following detailed description.

### BRIEF DESCRIPTION OF THE DRAWINGS

FIG. 1 is a schematic cross section drawing of a section of a prior art solid polymer electrolyte fuel cell that employs an O-ring type gasket attached to and impregnated into an edge portion of the MEA.

FIG. 2 is a schematic cross section drawing of the gasket region in a fuel cell of the invention, before compression, and illustrates the relevant dimensions of the projections on each separator plate.

FIG. 3A is a cross section drawing of the gasket region in the fuel cell of the Inventive Examples. The upper separator plate comprises an additional projection.

FIG. 3B is a schematic cross section drawing of a portion of a fuel cell stack of the invention in which one of the separator plates comprises an additional projection and which also shows cooling channels formed between adjacent separator plates.

FIGS. 4A, 4B, 4C, and 4D compare an embodiment of the invention to a conventional O-ring type seal and respectively show plots of burst pressure versus seal compression, burst pressure versus applied seal load, maximum principal stress versus seal compression, and maximum principal strain versus seal compression.

FIG. 5 shows the calculated design envelope for a potential embodiment of the invention in which both the gasket compression and sidewall angles of the separator plate projections are allowed to vary.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as “comprises” and “comprising” are to be construed in an open, inclusive sense, that is, as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present invention pertains to gasket seals for solid polymer electrolyte fuel cells and particularly to designs that seal at low compressive loads.

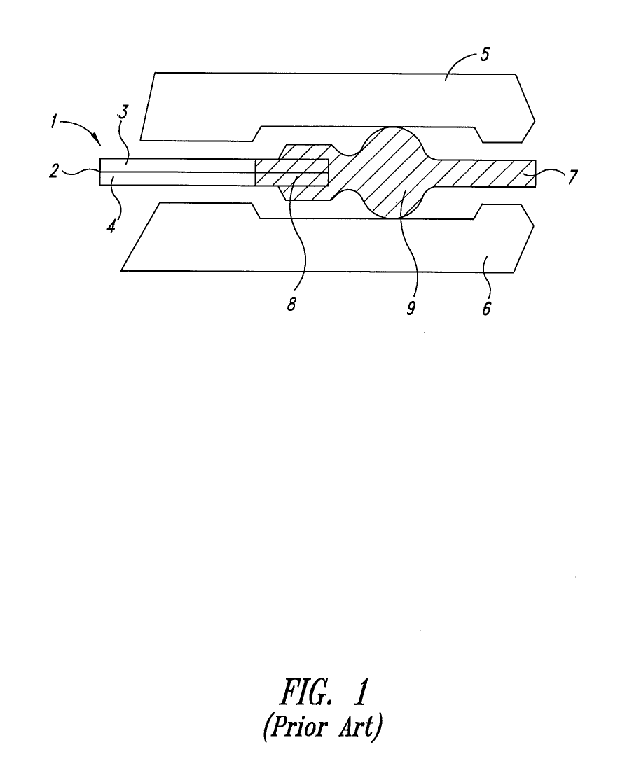

An uncompressed section of a prior art solid polymer electrolyte fuel cell is shown in the schematic cross section drawing of FIG. 1. The fuel cell comprises MEA 1 which in turn comprises ionomer electrolyte 2, anode and adjacent anode fluid diffusion layer 3 (appearing as a unit in this Figure), and cathode and adjacent cathode fluid diffusion layer 4 (appearing as a unit in this Figure). As shown here, MEA is “flush-cut”, i.e., the components making up the assembly all terminate together. (Typically, this is a result of cutting the assembly to the desired size after the components have been laminated together.) O-ring type gasket 7 is attached to and impregnated into edge portion 8 of MEA 1. Anode separator plate 5 and cathode separator plate 6 compress gasket 7 at O-ring portion 9 thereby effecting a seal between plates 5 and 6. Most of the compressive load where gasket 7 contacts plates 5 and 6 is in a direction normal to plates 5 and 6.

Typically, MEA 1, gasket 7, and plates 5 and 6 are all relatively thin (e.g., fractions of a mm in thickness) and there are practical limitations on the thickness tolerances which can be held on each. Due to tolerance stackups, especially in large series fuel cell stacks, there can be a significant possible variation in the compressive load applied where O-ring portions 9 contact plates 5 and 6 in the individual fuel cells. And, since the tolerances on the components do not generally scale with component thickness, the thinner the fuel cell, the greater the possible variation in compressive load can become. A certain minimum load is required of course to ensure an adequate seal. So to ensure this minimum is met for thinner fuel cells, either the tolerances must be tightened (which may be impractical in a manufacturing sense) or a greater maximum compressive load must be accepted. However, the latter results in greater stress on the gasket seal material, with a reduction in lifetime to due compression set of the seal. Also, a greater load can be problematic in crushing or damaging certain more sensitive areas of the components (e.g., bridges that span open areas underneath, such as fluid distribution plenums or channels).

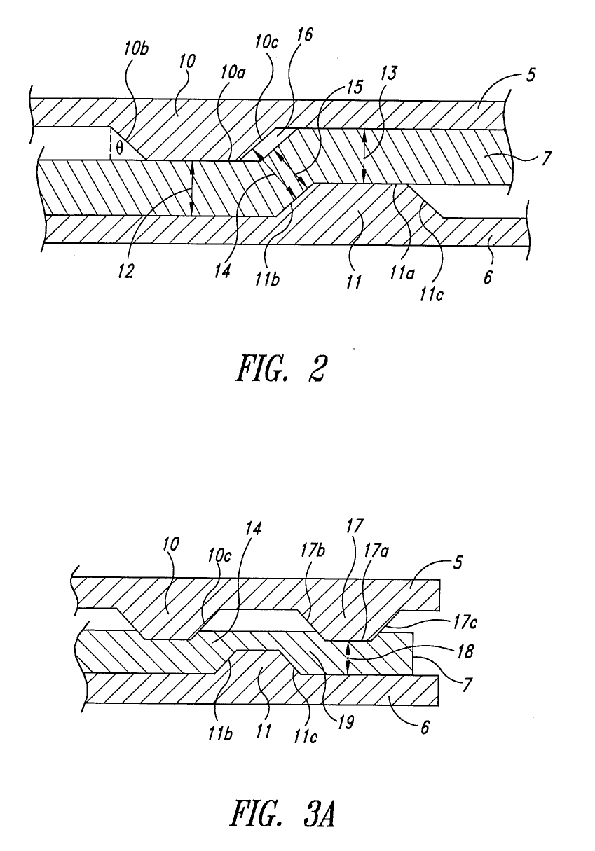

In a fuel cell of the invention however, the compressive load normal to the separator plates is reduced while still being able to maintain a robust seal and significant burst strength. The relevant features are illustrated in the schematic cross section drawing of FIG. 2. Here, the gasket region is shown uncompressed (i.e., prior to assembly and application of vertical loading).

In FIG. 2, anode separator plate 5 and cathode separator plate 6 each have peripheral projections, 10 and 11 respectively. Projections 10, 11 circumscribe the periphery of their respective separator plates and are proximate but offset from each other (in the vertical direction in FIG. 2). Anode projection 10 is characterized by projection surface 10a, inner sidewall 10b, and outer sidewall 10c. In a like manner, cathode projection 11 is characterized by projection surface 11a, inner sidewall 11b, and outer sidewall 11c. The projections define anode projection gap 12 and cathode projection gap 13 which appear between the projection surfaces and the opposite separator plates. Also, the projections define adjacent sidewall gap 14 between adjacent sidewalls 10c and 11b. The sidewalls are characterized in part by the angle they make with the direction normal to the separator plates (e.g., angle θ for sidewall 10b).

In the uncompressed state shown in FIG. 2, anode and cathode projection gaps 12 and 13 are the same height and projections 10, 11 and separator plates 5, 6 just contact gasket 7 in gaps 12, 13 (i.e., no significant compression). Sidewall gap 14 however is greater than the uncompressed gasket thickness 15 therebetween. Thus, there is empty volume 16 in sidewall gap 14 in this state prior to assembly/compression.

During assembly, gasket 7 is compressed by projections 10, 11 and gasket material gets displaced in both lateral directions. Gasket material from both projection gaps 12, 13 therefore gets displaced into the adjacent sidewall gap 14. With sufficient compression and associated displacement of gasket material, empty volume 16 gets filled with displaced gasket and applies force against surfaces 10b and 11c. Under sufficient compression, the gasket material directly between projection gaps 12, 13 and separator plates 5, 6 is however “locked” against lateral movement itself and thus does not slip and allow for relief of the force building up in adjacent sidewall gap 14. Because the gasket material that has filled sidewall gap 14 has nowhere to go and is essentially incompressible, this force can build up to be quite substantial and actually serve as the primary sealing force against leakage. In addition, the bulk of the force pushing against sidewalls 10c and 11b is not directed normal to the separator plates. Instead, a substantial portion of the force is directed laterally (i.e., parallel to the separator plates). The sealing force between sidewalls 10c and lb can therefore be quite large, and thereby seal against larger burst pressures, without requiring a large force or load applied normal to the separator plates.

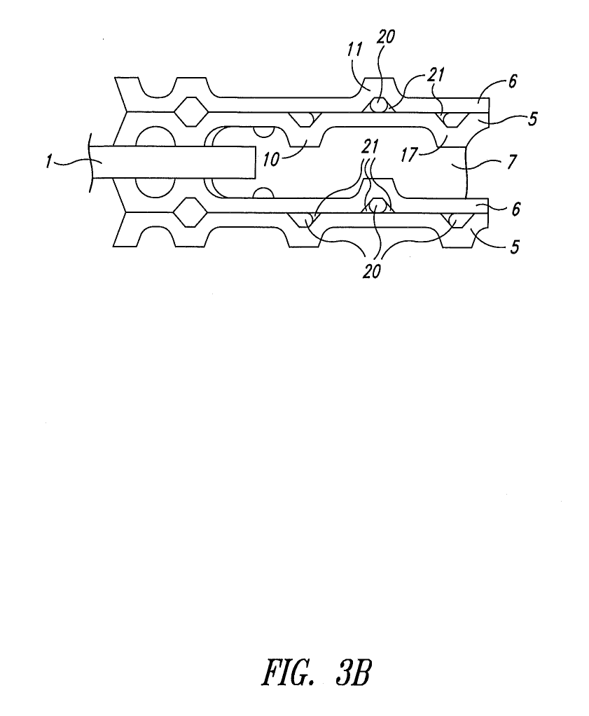

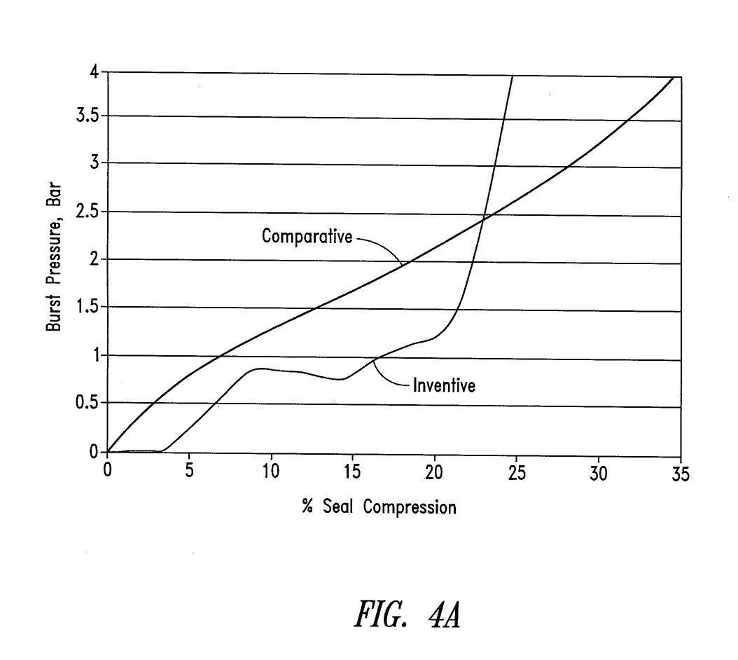

FIG. 3A is a cross section drawing of the gasket region in an assembled (i.e., compressed) fuel cell embodiment in which the upper anode separator plate comprises an additional projection. FIG. 3A uses like numerals to those in FIG. 2 in order to identify like features. However, anode separator plate comprises additional anode projection 17 that is characterized by projection surface 17a, inner sidewall 17b, outer sidewall 17c, and additional anode projection gap 18. In the assembled embodiment of FIG. 3A, adjacent sidewall gap 14 and additional adjacent sidewall gap 19 have been filled with displaced gasket material and substantial force is being exerted on sidewalls 10c, 11b, 11c, and 17b. A large component of this force is directed parallel to separator plates 5, 6. Gasket 7 is “locked” against slippage in projection gaps 12, 13, and 18.

The projection geometries/dimensions and gasket material properties must be coordinated properly in order to achieve these conditions and to seal against larger burst pressures without excessive loading normal to the separator plates. For instance, the strain on the gasket in the projection gaps should be prevented from exceeding the gasket material strain to failure (i.e., the strain at which the material fractures). On the other hand, the compression of the gasket in the projection gaps should be sufficient to “lock” the gasket and prevent slippage. For instance, in the embodiment discussed in the Examples below, the gasket should be compressed more than 10% in thickness in the anode and cathode projection gaps. Less than this and the compression from the projections could potentially allow the material to slide outwards from under the projections and relieve the lock between the adjacent sidewalls. And the minimum compression needed must be too little for sensitivity to manufacturing processes.

With reference to the unassembled embodiment in FIG. 2, one also has to employ projection geometries/dimensions such that the adjacent sidewall gap 14 and empty volume 16 accommodate an appropriate amount of displaced gasket material when under final assembled compression. To fill the empty space and obtain “hydraulic lock”, the cross-sectional area of the gasket (uncompressed) plus gasket material displaced by the projections into the sidewall gap must be greater than that of the sidewall gap following assembly. The force generated within the sidewall gap would be appropriate for a desired burst pressure and would have components directed both normal to and parallel to separator plates 5, 6. The force component normal to the separator plates is kept below a certain amount in order to avoid compression set of the gasket and damage to underlying features in the separator plates.

As other considerations, it may be advantageous to limit the maximum height of the projections to that of other features on the plate. Also it can be desirable for the projections to be as narrow as possible (i.e., smallest projection surfaces 10a, 11a, and sidewall angle θ) while still having enough cross-sectional area to displace an enabling amount of gasket material. This saves valuable in-plane separator plate area. In practical embodiments, the widths of the projection surfaces may be about equal to or greater than the heights of the projection surfaces. And, the sidewalls may be at angles of greater than 15 degrees with respect to a direction normal to the separator plates. With this general guidance, those of ordinary skill in the art can be expected to arrive at various embodiments employing different gasket material types and dimensions.

An additional advantage of this gasket seal design is that it allows for incorporation of cooling channels on the opposite sides of the projections. This provides an opportunity for incorporating cooling channels without increasing cell thickness. An example appears in FIG. 3B and depicts a schematic cross section drawing of a portion of a fuel cell stack in which anode separator plates 5 comprise an additional projection. (Again, FIG. 3B uses like numerals to those in the previous Figures in order to identify like features.) Cooling channels 20 are formed in the spaces opposite projections 10, 11, 17 and adjacent separator plates 5, 6 in the stack. Glue joints 21 may be employed for joining and sealing purposes and to obtain consistent results.

The low compressive load seal design is suited for use with various solid polymer electrolyte fuel cell constructions. The following examples are provided to illustrate certain aspects and embodiments of the invention but should not be construed as limiting in any way.

### EXAMPLES

A calculated comparison was made between a Comparative prior art O-ring type gasket/seal design for a fuel cell and that of an Inventive gasket/seal design. Qualitatively, the Comparative design was like that depicted in FIG. 1 while the Inventive design was like depicted in FIG. 3A. In the Comparative example, the O-ring was a silicon based elastomer that was 1.85 mm in diameter. For purposes of calculation, the O-ring was assumed to be compressed between flat separate plate surfaces. In the Inventive Example, the gasket was made of the same material and was flat with a thickness of 0.5 mm. Further, the separator plate projections were all 0.25 mm in height, 0.23 mm in width, and had sidewall angles that were 45 degrees from a normal direction to the separator plates. (Only a two projection design was actually considered in these calculations, as it was assumed that the results would be symmetrical about the cathode projection 11.)

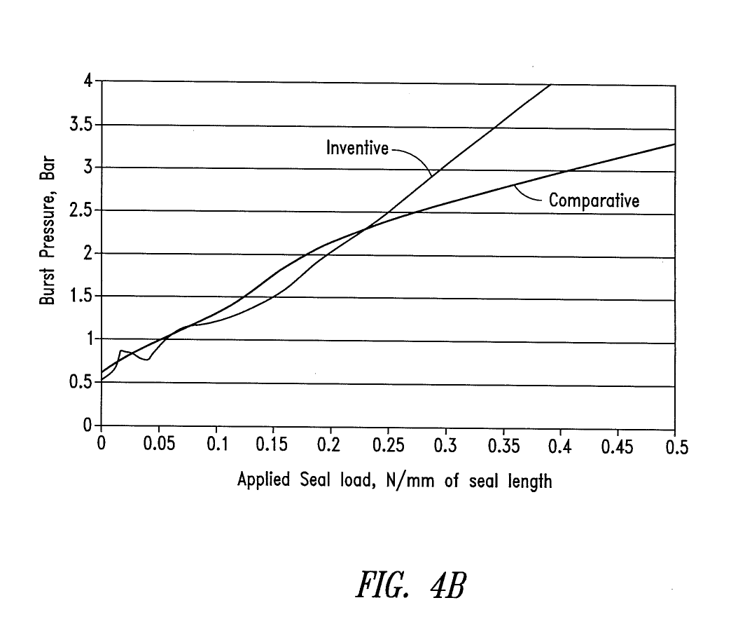

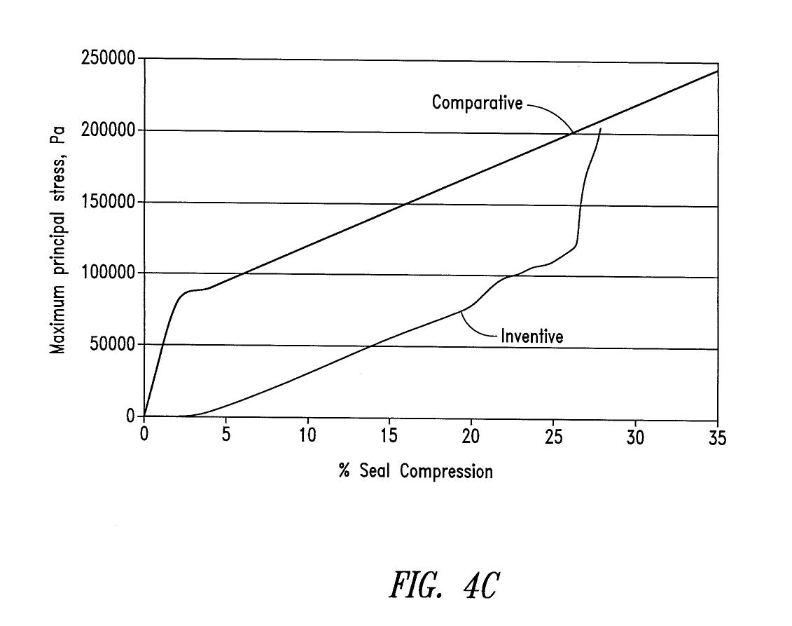

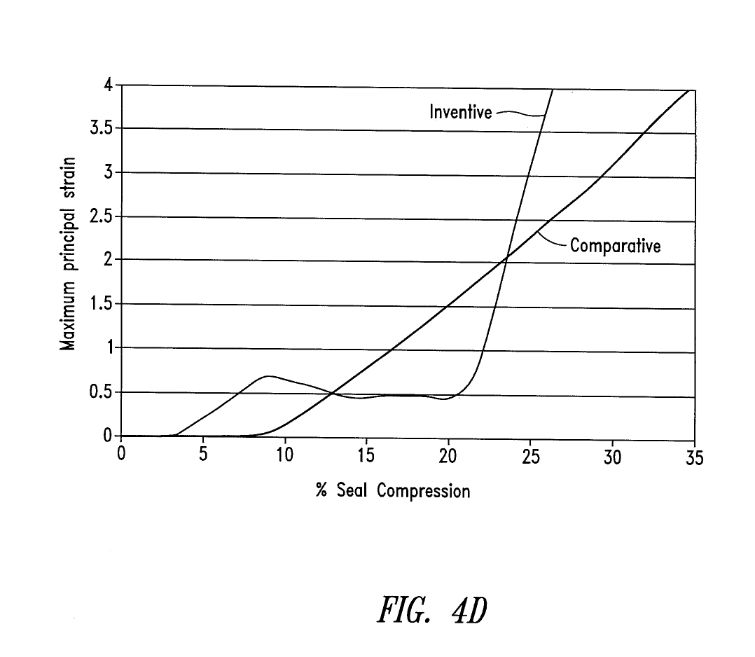

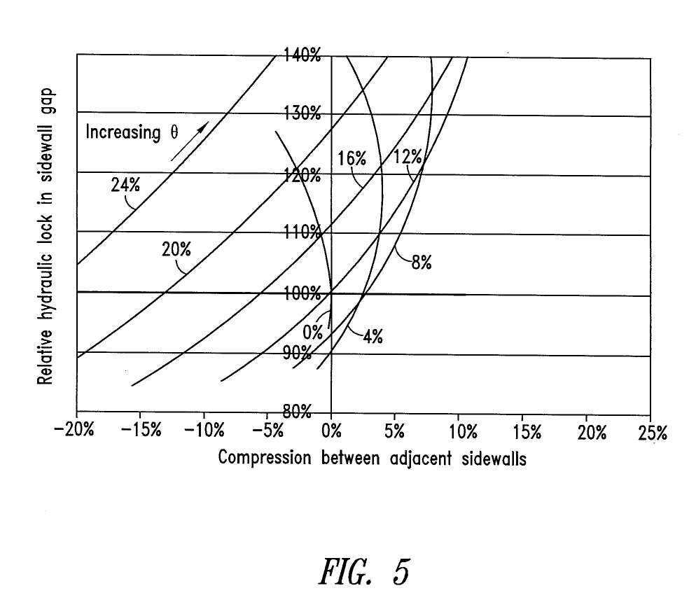

FIG. 4A shows the predicted burst pressure versus % seal compression for these Comparative and Inventive examples. (Note that in the case of the Inventive Example, FIGS. 4A-D refer to the compression of the gasket normal to the projection surfaces.) In this particular comparison, the two designs provide the same burst pressure of about 2.5 bar at about the same approximate 23% gasket compression. However, FIG. 4A shows that above 2.5 bar, the Inventive example provides a greater burst pressure at significantly less compression than the Comparative example.

FIG. 4B shows a similar result as in the preceding except that here, burst pressure has been plotted versus applied load along the seal (in N/mm of seal length) for both the Comparative and Inventive examples. Again, the Inventive Example provides a significantly greater burst pressure at less applied load along the seal than does the Comparative Example.

FIGS. 4C and 4D show the calculated maximum principal stress and maximum principal strain respectively versus % seal compression for the Comparative and Inventive examples. As is apparent from FIG. 4C, the maximum principal stress in the Inventive example is lower than in the Comparative example at seal compressions below about 28%. While the burst pressure for both designs is 2.5 bar at 23% compression, the maximum principal stress is about 40% lower in the Inventive example. The maximum principal strain is the same for both at this 2.5 bar burst pressure (FIG. 4D). At a maximum principal strain of 30% (0.3) for the seal material, the Inventive example seals at about 4 bar versus about 3.2 bar for the Comparative example, i.e., approximately 25% higher.

FEA analysis was also carried out on the example designs and the results were consistent with the preceding. The higher burst pressure at lower seal compression and applied seal load results were confirmed. The maximum principal stress and strain at desirable seal compression design points would be reduced. These results show how the projection based design of the invention can be used to achieve higher burst pressure at lower loads normal to the separator plates.

FIG. 5 is presented to illustrate the design envelope for a seal design similar to that employed in the Inventive example. (The width of the projections in this case was taken to be 0.25 mm, not 0.23 mm.) Each curve presented here represents a different gasket compression (as indicated in %) under the projections (e.g., gaps 12, 13) over a range of sidewall angles θ. The X axis in FIG. 5 represents compression between the adjacent sidewalls in direction 116 as shown in FIG. 2. The Y axis represents relative hydraulic lock in adjacent sidewall gap 14 when assembled. That is, if sidewall gap 14 is just filled with displaced gasket material, the relative hydraulic lock is considered to be 100%. If it were calculated that there would be 10% more material than available volume, the relative hydraulic lock would be considered to be 110%. Or conversely, if calculations indicated there would be 10% free volume, the relative hydraulic lock would be 90%. For each curve, the relative hydraulic lock increases with increasing sidewall angle (θ). [Note: compressions were calculated using the gasket thickness and the distance between the contacting surfaces, i.e., uniaxial compression normal to those surfaces.]

FIG. 5 thus illustrates under what conditions hydraulic lock occurs (i.e., greater than 100% relative hydraulic lock) within the adjacent sidewall gap, which is a necessary condition for this low compressive load seal. The effect and importance of sidewall angle θ is also apparent. (The sidewall angle affects the total cross sectional area of the projections, which must be large enough to displace enough gasket material into the adjacent sidewall gap.)

For a feasible design, the compression under the projections (gaps 12, 13) must be non-zero but also more than the compression between the projection sidewalls, so that the friction under the projections is always higher (regardless of material choices employed). This ensures that the compressed gasket will not be able to slide out from under the projections and relieve hydraulic lock in the adjacent sidewall gap when the separator plates are brought together during assembly.

Based on the results shown in FIG. 5, it is considered desirable to have >12% compression under the projections so that the results are less sensitive to manufacturing tolerance related variations in the components (for instance, the curve for 12% compression is far less steep than the curves for lower % compression).

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A solid polymer electrolyte fuel cell comprising:
a membrane electrode assembly comprising an ionomer electrolyte disposed between an anode and a cathode, an anode fluid diffusion layer adjacent the anode, and a cathode fluid diffusion layer adjacent the cathode;
an anode separator plate adjacent the anode fluid diffusion layer, a cathode separator plate adjacent the cathode fluid diffusion layer, and a gasket surrounding the membrane electrode assembly and compressed between the anode and cathode separator plates so as to seal the membrane electrode assembly between the plates;
wherein each of the anode and cathode separator plates comprises a peripheral projection facing the opposite separator plate, the projections being proximate but offset with respect to each other;
wherein each projection comprises a projection surface and inner and outer projection sidewalls, the separator plates thereby defining an anode projection gap between the anode plate projection surface and the cathode plate, a cathode projection gap between the cathode plate projection surface and the anode plate, and an adjacent sidewall gap between the adjacent projection sidewalls of the anode and cathode plate projections;
wherein the adjacent sidewall gap would be greater than the uncompressed gasket thickness if the separator plates were separated in a direction normal to the plane of the separator plates such that the larger of the anode and cathode projection gaps equaled the uncompressed gasket thickness;
wherein each projection surface applies a compressive load to the gasket in a direction normal to the separator plates thereby displacing gasket material from the projection gaps into the adjacent sidewall gap; and
wherein the volume in the adjacent sidewall gap is completely filled with gasket material and the adjacent sidewalls of the anode and cathode projections apply a compressive load to the gasket at least in part in a direction parallel to the separator plates.

2. The fuel cell of claim 1 wherein the anode and cathode projection gaps are large enough to prevent the strain on the gasket in the projection gaps from exceeding the gasket material strain to failure.

3. The fuel cell of claim 2 wherein the gasket is made of silicone based elastomer.

4. The fuel cell of claim 3 wherein the gasket is compressed up to 25% in thickness in the anode and cathode projection gaps.

5. The fuel cell of claim 4 wherein the gasket is compressed more than 10% in thickness in the anode and cathode projection gaps.

6. The fuel cell of claim 1 wherein the dimensions of the anode plate projection are the same as the dimensions of the cathode plate projection.

7. The fuel cell of claim 6 wherein the widths of the projection surfaces are about equal to or greater than the heights of the projection surfaces.

8. The fuel cell of claim 6 wherein the sidewalls are at an angle of greater than 15 degrees with respect to a direction normal to the separator plates.

9. The fuel cell of claim 1 comprising an additional peripheral projection on one of the separator plates, the additional projection facing the opposing separator plate and proximate to but offset from the projection on the opposing plate.

10. The fuel cell of claim 1 wherein the burst pressure of the seal is greater than about 2.5 bar.

11. The fuel cell of claim 10 wherein the compressive load at the anode and cathode projection surfaces is less than 0.25 N/mm.

12. The fuel cell of claim 1 wherein the gasket is attached to and impregnated into an edge portion of the membrane electrode assembly.

13. The fuel cell of claim 1 wherein the separator plates are made of carbon.

14. A fuel cell stack comprising a plurality of the fuel cells of claim 1 in a series stack.

15. The fuel cell stack of claim 14 wherein the separator plates comprise depressions opposite the projections and the depressions define channels for coolant between adjacent anode and cathode separator plates.

16. The fuel cell stack of claim 14 wherein the anode separator plate of a fuel cell in the stack is unitary with the cathode plate of the adjacent fuel cell in the stack.

17. A method of reducing the compressive load applied by a compressed gasket to separator plates in a solid polymer electrolyte fuel cell, in which the fuel cell comprises a membrane electrode assembly comprising an ionomer electrolyte disposed between an anode and a cathode, an anode fluid diffusion layer adjacent the anode, and a cathode fluid diffusion layer adjacent the cathode; an anode separator plate adjacent the anode fluid diffusion layer; a cathode separator plate adjacent the cathode fluid diffusion layer; and a gasket surrounding the membrane electrode assembly and compressed between the anode and cathode separator plates so as to seal the membrane electrode assembly between the plates, the method comprising:
incorporating the projections of claim 1 on each of the anode and cathode separator plates; and
applying a compressive load with each projection surface to the gasket in a direction normal to the separator plates thereby displacing gasket material from the projection gaps into the adjacent sidewall gap, and wherein the volume in the adjacent sidewall gap is completely filled with gasket material and the adjacent sidewalls of the anode and cathode projections apply a compressive load to the gasket at least in part in a direction parallel to the separator plates.

18. The method of claim 17 wherein the gasket is compressed between 10% and 25% in thickness in the anode and cathode projection gaps.

19. The method of claim 17 wherein the compressive load applied by the compressed gasket to the separator plates is reduced such that the compressive load at the anode and cathode projection surfaces is less than 0.25 N/mm.
